(19) United States
(12) Patent Application Publication
(10) Pub. No.: US 2003/0144955 A1
(43) Pub. Date: Jul. 31, 2003

(54) Electronic payment system on internet and method the same

(76) Inventor: Kwang-Chul Kim, Busan (KR)

Correspondence Address: Leopold Presser, Scully Scott Murphy & Presser, 400 Garden City Plaza, Garden City, NY, 11530, US

(21) Appl. No.: 10/332,669

(22) PCT Filed: May 29, 2001
(86) PCT No.: PCT/KR01/00902

(30) Foreign Application Priority Data
Jul. 10, 2000 (KR) 2000/39210

(51) Int. Cl. G06F 17/60

(52) U.S. Cl. 705/40

(57) ABSTRACT

Disclosed are an electronic payment system on Internet and a method the same, which eliminate the need that a consumer's card information should be provided to shopping malls when purchase is carried out on web sites connected on line by setting an electronic payment engine, on which a form analyzing robot is mounted, in a client server and setting an electronic certification engine in a financial company server, extract fields corresponding to the amount of money requested during the certification and the payment by analyzing forms required to be inputted for the payment, perform the filling up by using the analyzed information about the fields required to be data-inputted and pre-stored data, and conduct the payment for the purchase by using varying in information, such as certification information.

### TECHNICAL FIELD

The present invention generally relates to an electronic payment system on Internet and a method the same, and in particular, to an electronic payment system on Internet and a method the same, which can exclude a consumer' card information from being forwarded to a shopping mall at a point of purchase on a web site connected on line, exact fields corresponding to an amount of money necessary for an authentication and a settlement by analyzing a form required to be inputted for the settlement perform a filing by using the analyzed information about the fields required to be data-inputted and pre-stored data, and conduct the settlement for the purchase by using varying information, such as an authentication information.

### BACKGROUND ART

As Internet-related technology has been developing, various types of services are carried out through World Wide Web. A medium on line, namely Internet, is gradually becoming means for realizing an electronic commerce between a government, a company and a consumer beyond only information communication means.

The electronic commerce signifies all economic activities, including selling products and services, ordering, advertising, etc., through computer networks. Accordingly, much attention has inevitably been paid to solutions for realizing malls, electronic payment, delivery, authentication, and security.

In this circumstance, if a consumer visits a shopping mall, inquires about a product, and purchases the product, the shopping mall requires the client to input a certain information for a settlement. Therefore, the consumer writes and forward a credit card information as well as a personal information to the shopping mall, and the shopping mall gets to have the personal information and credit card information.

Thus, the consumer is worried about a risk that the personal information and the credit card information stored in the shopping mall would be leaked and illegally used by a third party. In actual fact, there are often happened the information provided by consumers to such shopping malls is leaked and misused by third parties. Such a problem is occurred not only in the shopping malls but also in all web sites, which realize the electronic commerce through the Internet.

It is also true that the web sites realizing the electronic commerce make attempts to avoid the personal information leakage due to an artificial way, such as a hacking, by building a firewall in a direct manner. As an indirect and client selectable manner, an electronic wallet or an electronic money has been developed.

However, since the web site is in possession of the consumer's credit card information, whose leakage could inflict an economic disadvantage to the consumer, it is hard to solve a basic problem. Even in case of the electronic wallet or the electronic money, since the information is provided to the web site realizing the electronic commerce, the aforementioned problem still remains.

Hence, the conventional art has the disadvantage of suffering deterioration in reliability of such web sites as shopping malls where purchases are conducted, since consumers are reluctant to give an order through on-line.

In this regard, there is needed to disclose a method for solving the aforesaid problems.

### DISCLOSURE OF INVENTION

It is, therefore, an object of the present invention to provide an electronic payment system on Internet and a method the same, which can prevent an economic damage on a consumer and relieve distrust of an electronic commerce, in a manner that such a settlement information as a consumer card number is not managed in a web site, i.e., a shopping mall, etc., where the electronic commerce is realized.

It is another object of the present invention to provide an electronic payment system on Internet and a method the same, which can exclude such a settlement information as the consumer card number from being forwarded to the web site where the electronic commerce is realized, in a manner that a financial company manages the settlement information, the consumer requests an authentication with a pre-assigned account, and thus the settlement is carried out by the account information.

It is still another object of the present invention to provide an electronic payment system and a method the same, which can give the client convenience in use, in a manner that fields required to be inputted in the web site at a point of settlement are automatically filled without being inputted one by one by the consumer.

To achieve the above objects, there is provided to an electronic payment system on Internet, the system comprising: a client server having an electronic payment engine with an electronic payment program bring set up, for requesting an authentication with a code pre-assigned by a financial company at a point of settlement for a purchase through Internet, with a received authentication information being permitted as a settlement information, and transferring the settlement information and delivery information with respect to a purchased product; a financial company server having an electronic authentication engine for performing an authentication together with the electronic payment engine on line through the Internet, wherein the electronic authentication engine checks whether or not the authentication is permissible upon receiving the authentication request from the client server ad transfers the authentication information to the pertinent client server; and a web site operating server for realizing an electronic commerce through the Internet, requesting to the financial company server whether the settlement is authentic based on the settlement information transferred from the client server, and forwarding an order confirmation document in relation to the settlement verified product to the client server, and outputting the delivery information.

Here, an analyzing robot is mountable on the electronic payment engine when the electronic payment program is set up. It is desirable that the analyzing robot analyzes a form transferred for the settlement from the web site operating server.

It is desirable that a delivery place information and a code information pre-assigned from the financial company are registered on the electronic payment engine, a tray including a menu for determining the delivery place and performing the settlement is driven by the electronic payment engine, and the client transfers the delivery information and settlement information to the web site operating server by means of the tray.

It is desirable that the tray is adapted to fill an information required to be inputted in the form provided by the web site operating server at the point of settlement.

It is desirable that the electronic payment engine stores a data for a predetermined advertisement, and the try is adapted to output the advertisement to the client server for a predetermined period of time after the authentication request.

It is desirable that the electronic authentication engine creates the authentication information as a pre-authentication information and transfers the authentication information when the client server requests the authentication, produces a definite authentication number when the web site operating server requests the settlement verification, and transfers the definite authentication number to the web site operating server.

In an electronic payment method according to the present invention for realizing the electronic commerce between the client server, the web site operating server and the financial company server, which are connected through Internet, the method comprises the steps of searching, in the client server, products selling in the web site operating server and selecting the settlement, and outputting a settlement screen of a predetermined form for the settlement; performing, in the client server, the authentication request for a settled amount of money to the financial company by means of the tray driven by the electronic payment engine in which such information as the client's personal information, the delivery information, and the settlement code information pre-assigned by the financial company are registered; transferring, in the financial company server, the authentication information with respect to the authentication request to the client server; transferring, in the client server, an order information to the web site operating server by means of the tray with the authentication information as the settlement information; requesting, in the web site operating server, a settlement verification based on the authentication information transferred from the client server to the financial company server; transferring, in the financial company server, an information, which has been settlement-verified after being inquired about upon receiving the settlement request; and forwarding, in the web site operating server, an order confirmation document and the delivery information to the client server and the delivery company server after receiving the settlement verified information.

### BRIEF DESCRIPTION OF THE DRAWINGS

Further objects and advantages of the invention can be more fully understood from the following detailed description taken in conjunction with the accompanying drawings, in which:

FIG. 1 is a view illustrating a construction of a preferred embodiment of an electronic payment system on Internet according to the present invention;

FIG. 2 is a flow chart for explaining a method for realizing the preferred embodiment of the present invention;

FIG. 3 is an exemplary view of a settlement screen;

FIG. 4 is an exemplary view of a tray generated by an electronic payment engine; and

FIG. 5 is a flow chart for explaining a method for driving the electronic payment engine of FIG. 1.

### BEST MODE FOR CARRYING OUT THE INVENTION

The present invention will now be described in connection with a preferred embodiment with reference to the accompanying drawings.

The present invention realizes an electronic commerce in a state that a settlement information, such as a consumer card information, is excluded from being forwarded to a shopping mall.

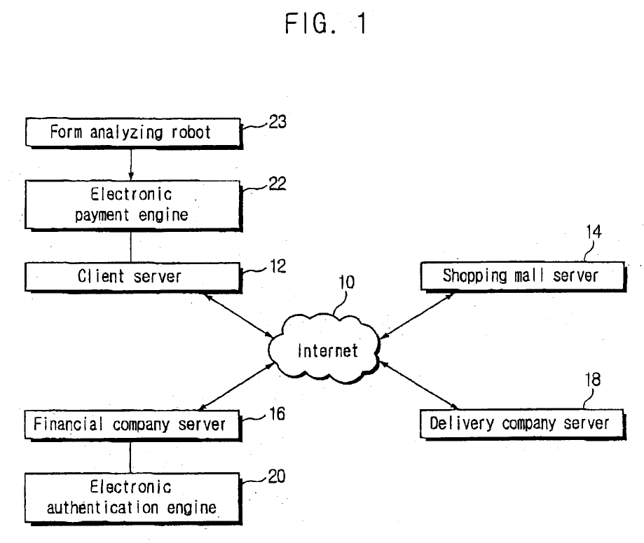

FIG. is a view of a preferred embodiment of the present invention. Referring to FIG. 1, an electronic payment system comprises Internet 10 as an on line medium, a client server 12 for performing communications through Internet 10, a shopping mall server 14, a financial company server 16, and a delivery company server 18, all of which realize the electronic commerce and basically include operating systems i.e., Explorer, Netscape, window NT, Linux, etc., and programs operated by a convertible protocol on line. Therefore, the client server 12, the shopping mall server 14, the financial company server 16 and the delivery company server 18 are connected through be Internet.

An electronic payment program for realizing the electronic commerce according to the present invention is set up in the client server 12, and an electronic payment engine on which a form analyzing robot 23 is mounted is accordingly set on the client server 12. An electronic authentication engine 20 having a protocol for performing communications with the electronic payment engine 22 is set on the financial company server 16.

Here, the electronic payment engine 22 drives a tray at a point of time when the client server 12 is initially driven or a consumer wants, and a basic personal information about the consumer or the client, a delivery place information for the electronic commerce, and an account number or a card number which is pre-assigned by a financial company, are registered on the electronic payment engine 22. All the information is required and inputted at a point of time when the electronic payment program is initially set up, and may be updated at any time in accordance with the consumer demand.

The form analyzing robot 23 analyzes a form composing a settlement screen downloaded on the client server 12, and extracts a settled amount of money and fields required to be inputted through the analysis. The settled amount of money is used for performing an authentication. The fields required to be inputted may be filled by using data stored in the electronic payment engine 22, which will be explained later.

The financial company server 16 is a common designation of servers operated by a credit card company or a bank connected trough a financial Value Added Network (VAN), and is applicable to all servers of financial companies, which can perform the authentication of the electronic settlement. Also, an electronic authentication engine is built on the financial company server 16. Accordingly, if the client applies for issuance of the client account and secret number or the client card through the financial company server 16, the electronic authentication engine 20 issues a pertinent account code and a secret number of the account code or a card number and a secret number of the card number, whereas if there is an authentication request with respect to a pre-issued account code and a secret number, the electronic authentication engine 20 performs the pertinent authentication.

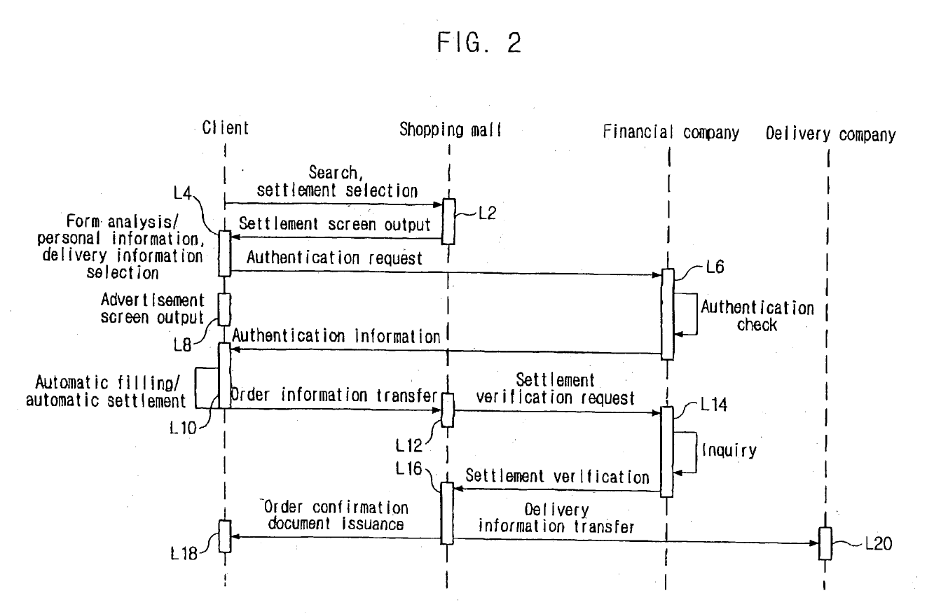

Method for operating the system according to the present invention will be explained herein after in detail with reference to FIG. 2 through FIG. 5.

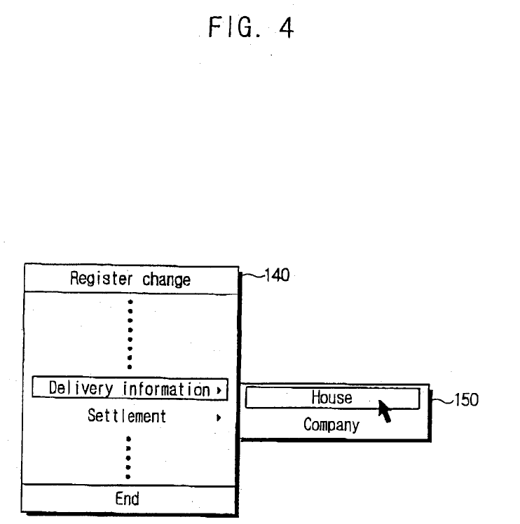

The client receives the account and the secret number of the account, or the card number and the secret number of the card number for the electronic settlement as stated above, downloads an electronic payment program, which is registered on a home page operated by the financial company, and sets up the electronic payment program on the individual client server 12. At this time, the personal information, the delivery place information, the settlement information (including, the account and the secret number of the account or the card number and the secret number of the card number) are required to be inputted, and after the initial information registration step is finished, a tray of FIG. 4, which is operated by the electronic payment engine 22, is used to perform the settlement step of FIG. 2.

Here, the electronic payment program for setting the electronic payment engine 22 having the form analyzing robot 23 on the client server 12 may be distributed as a record storage medium like a compact disk or a floppy disk

The client can write and transfer data necessary for the pertinent form by a method where the client uses the tray and selects and clicks a menu, or a drag and drop method where the client selects a menu and drag and drop a data, or a manual method.

In the aforementioned environment, the consumer, namely client, inputs the account and secret number pre-assigned by the financial company, drives the tray 140 on the client server 12, connects the Internet 10, and inquires of a product to be purchased. In this course, the client server 12 may be connected to the shopping mall server 12 handing the pertinent product through the Internet.

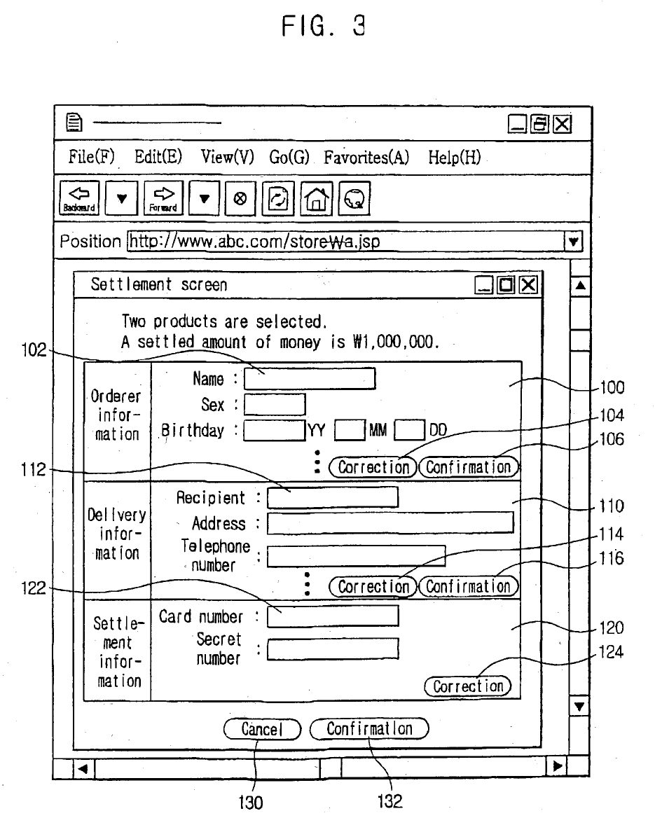

If the client wants the settlement, the shopping mall server 14 outputs a settlement screen at a step L12. After the client downloads the settlement screen of FIG. 3 provided from the shopping mall server 14, the client selects the delivery information and selects the settlement by using the tray 140. Once the client selects the settlement by using the tray 140, the client server 12 drives the electronic payment engine 22 and analyzes the form composing the downloaded settlement screen by using the mounted form analyzing robot 23 at a step L4,

To be specific, if the settlement screen of FIG. 3 is output to the client server 12, the user clicks the “delivery information” displayed as the menu on the tray as shown in FIG. 4 to show an auxiliary window 150, and selects and determines either among “house” and “company” as the delivery place.

After the above form analyzing and delivery information selecting step L4 is finished in the client server 12, if the client selects the “settlement” of the tray 140, the form analyzing robot 23 performs the form analysis of the currently downloaded settlement screen under the control of the electronic payment engine 22.

The form analyzing robot 23 has an existing standard data for analyzing the form, accordingly analyzes a source code of a HTML document composing the settlement screen and recognizes a field name or a tag contained in the source code, extracts fields to be used for the authentication or settlement later, such as a settled amount of money, and judges characteristic of the fields to be input required with reference to the standard data. Hence, the form analyzing robot 23 judges what the fields, which are required to be inputted, such as the settled amount of money contained in the settlement form, are like.

In the settlement screen of FIG. 3, a message is output indicating the information containing the amount of money for the product which the client selected, for example, “two products were selected and the settled amount of money is \1,000,000”. The settlement screen is divided into an orderer information area 100, a delivery information area 110, and a settlement information area 120. In the orderer information area 100, an area 102 is set to require an input of a personal information, such as name, sex, birthday, etc., and buttons 104 and 106 are set to correct or confirm the information. And, in the delivery information area 110, an area 112 is set to require an input of an information, such as recipient, address, telephone number, etc., and buttons 204 and 206 are set to correct and confirm the information. Moreover, in the settlement information area 120, an area 122 is set to require an input of such an information as card number, secret number etc., and a button 124 is set to correct the information. Additionally, buttons 130 and 132 are set in the settlement screen to cancel and finally confirm the order.

It is out of question that the orderer information area 100, the delivery information area 110 and the settlement information area 120 may be formed on separate screens.

In the above analyzing step, the amount of money information and input fields contained in the respective areas 100, 110 and 120 are analyzed.

After the analysis of the settlement screen is completed, the settlement information (the account and the secret number of the account or the card number and the secret number of the card number) is transferred to the financial company server 16 and the authentication is requested.

Depending on the manufacture's intention, the embodiment of the present invention may permit the client to directly write the information necessary for the authentication with reference to the settlement screen without performing the settlement screen analyzing step. The amount of money information and the settlement information are transferred to the financial company server 16 and adequately changed so as for the authentication to be requested.

Meantime, the electronic payment engine 22 previously stores advertisement contents and outputs the advertisement contents when the client server 12 requests the authentication at a step L8. The output of the advertisement contents may be continued until the client server 12 receives the authentication information or the order confirmation document.

If the client server 12 requests the above authentication, the financial company server 16 transfers the received information to the electronic authentication engine 20 and checks whether the information is authentic. If the information is judged to be authentic as a result of the check, the authentication information is transferred to the pertinent client server 12. If the information is not trustworthy, an information including a message indicating that the authentication was rejected is generated and transferred to the client server 12 through the Internet 10.

At his time, the electronic authentication engine 20 of the financial company server 16 generates an authentication information by differentiating it from the card number but rendering it having the same digit as the card number. In the event that there is needed a secret number of the authentication information, the electronic authentication engine 20 generates the secret number and transfers the generated secret number, or transfers an existing secret number.

To be specific, if the client transfers the settled amount of money corresponding to \1,000,000, the account code (for example, “abcdefg”), and the secret number of the account code (for example, “1234”, or the card number (for example, “1234-1234-1234-1234”) and the secret number of the card number(for example, “1234”)) to the financial company server 16, the financial company server 16 generates the authentication information through the authentication checking step L6, wherein the authentication information has the same digit as the card number or the secret number required in the settlement screen (for example, “5678-5678-5678-5678” and “0987”), and transfers the authentication information to the client server 12 through the Internet 10.

At that time, the financial company server 16 may transfer a pre-authentication number as the authentication information or a definite authentication number as the authentication information.

The electronic payment engine 22 of the client server 12 receives the contents transferred from the financial company server 16, outputs a pertinent message when the authentication was rejected, and fills the pertinent data in the input areas 102,112, and 122 of the analyzed settlement screen when the authentication w permitted.

As for the data inputted as the settlement information of the settlement screen, since the authentication information irrelevant to the client card number or the account is inputted, the following information, which can not be repeatedly used is provided to the shopping mall server 14.

After the electronic payment engine 22 completes the filing, the electronic payment engine 22 makes the confirmation button 132 being clicked by a push and performs an automatic settling step L10. As a result, the order information is transferred to the shopping mall server 14 without conducting a troublesome button manipulation for the settlement by the client. Of course, the cofirmation button may be pushed in a manual way. If the secret number is required to be filled in the settlement form, the very secret number used during the authentication may be inputted.

The shopping mall server 14 uses the delivery information and the settlement information as the information necessary for the settlement and perform a settlement verification requesting step L12.

In the settlement verification requesting step L12, the shopping server 14 transfers the settlement information transferred by the client to the financial company server 16, and the electronic authentication engine 20 refers to the pre-issued authentication number and the pertinent secret number and transfers the settlement verification message to the shopping mall server 14.

At his time, the electronic authentication engine 20 generates the definite authentication number if the authentication number transferred as the settlement information is the pre-authentication number, and contains the definite authentication number in the settlement verification message and then transfers the definite authentication number.

If the shopping mall server 14 receives the settlement verification message, the shopping mall server 14 issues the order confirmation document to the client server 12 and simultaneously transfers the delivery information to the delivery company server 18 operated by the delivery company. If the client server 12 receives the order confirmation document, the client server informs the reception to the client and stores the order confirmation document at a step L18. If the delivery information is delivered to the delivery company server 18 through the Internet 10, the delivery company accordingly performs a delivery process at a step L20.

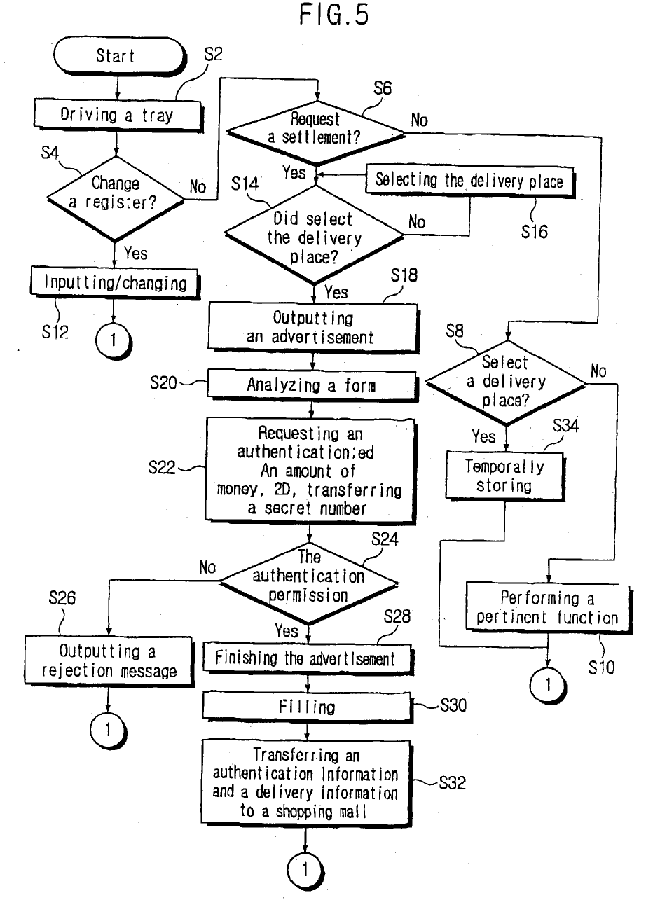

In the above course, the electronic payment engine 22 of the client server 12 drives the tray 140 and is operated as shown in FIG. 5 for performing the steps in the flow chart of FIG. 2.

To be specific, the tray 140 requires an input of the client account and the secret number in an initial driving step S2. The account and the secret number are pre-assigned by the financial company as stated above.

After being driven, the tray 140 scans if it will change the account, the secret number, the delivery information, etc., which are registered at a step S4, if there is a settlement requirement at a step S6, if the delivery place will be selected at a step S8, or other pertinent function definable in the menu will be performed at a step S10.

In order to change the registered data, i.e, the account, the secret number, the delivery information, etc., if the client clicks “register” of the tray 140 at the step S4, the electronic payment engine 22 requires the input the personal information and the delivery place information, and if the client inputs the required matters, the electronic payment engine 22 stores or modifies the pertinent contents and changes the contents at a step S12 and continuously performs the scan operation.

In order to select the delivery place, if the “delivery information” of the tray 140 is clicked at the step S8, the electronic payment engine 22 outputs the auxiliary window 150 showing “house, and “company”, which were previously designated as the delivery place. If either of them is selected, the electronic payment engine 22 temporally stores the contents at a step S34 and continuously performs the scan operation. The temporally stored contents are used when the settlement is carried out.

Meantime, in order to require the settlement, if the “settlement” of the tray 140 is clicked at the step S6, it is conformed if the delivery place was selected at a step S14. If the delivery place was not selected, the auxiliary window 150 is output, the delivery place information is attained, and the step S14 is proceeded with again. If the delivery place was selected, however, the electronic payment engine 22 outputs the preset advertisement at a step S18 and analyzes the form of the settlement screen at a step S20. The form analysis is carried out by the form analyzing robot 23 mounted on the electronic payment engine 22, and the price information and the fields to be inputted included in the settlement screen are grasped through the form analysis.

Then, the electronic payment engine 22 requests the authentication to the financial company and transfers the settled amount of money, the account the URL of the shopping mall, and the pertinent secret number(or the card number and the pertinent secret number) to the financial company server 16 through the Internet 10 for the settlement request at a step S22.

The electronic payment engine 22, thereafter, judges whether the authentication information is arrived at a step S24, outputs a rejection message if the rejection message is arrived at a step S26, returns to the initial tray driving step, finishes the currently outputting advertisement if the authentication information is arrived at a step S30 and fills the pertinent contents in the input areas of the analyzed settlement screen at a step S30.

The electronic payment engine 22 automatically clicks the “confirmation” button of the settlement screen if the filling is completed, transfers the authentication information and the delivery information to the shopping mail at a step S32 and returns to the initial tray driving step.

While the invention has been shown and described with reference to certain a preferred embodiment thereof, it will be understood by those skilled in the art that various changes in form and details may be made therein without departing from the spirit and scope of the invention as defined by the appended claims.

### INDUSTRIAL APPLICABILITY

As stated above, the present invention has an advantage of allowing a consumer to purchase a wanted product on Internet and use an on line service, since a web site performing a sale of the predetermined product or the on line service uses a client server and not in possession of an information, such as an account or a card number assigned by a financial company of the consumer at a point of settlement, and the consumer does not need to forward the information, whose leakage would inflicts an economic disadvantage on the consumer, to a shopping mall for the settlement.

The present invention has accordingly advantages of providing security to the consumer in using an electronic commerce through the Internet and of improving reliability in the web site realizing the electronic commerce.

The present invention has further another advantages of enabling the web site to realize the electronic commerce without separate security means or fire prevention technology, and of eliminating a risk of causing disputes due to a personal settlement information leakage or an illegal use of the personal settlement information during the electronic commerce.

The present invention still another advantage of enhancing convenience in use, since the client can easily fill the settlement information by using an information registered and analyzed in an electronic payment engine.

The present invention yet another advantage of promoting utility, since there is no need of a program adjustment for a self operation, i.e, a tray transfer, a protocol consistency, etc., in the shopping mall or the web site requiring the electronic commerce, and the client can perform the electronic commerce with any web sites having an account in a financial company like a card company.

What is claimed is:

1. An electronic payment system on Internet, comprising:
a client server having an electronic payment engine with an electronic program being set up, for requesting an authentication based on a code pre-assigned by a financial company at a point of settlement for a purchase through the Internet with a received authentication information being permitted as a settlement information, and transferring the settlement information and a delivery information with respect to a purchased product;
a financial company server having an electronic authentication engine for performing an authentication together with the electronic payment engine on line through the Internet, wherein the electronic authentication engine checks whether or not the authentication is permissible upon receiving the authentication request from the client server and transfers an authentication information to the pertinent client server; and
a web site operating server for realizing an electronic commerce through the Internet, requesting to the financial company server whether the settlement is verified based an the settlement information transferred from the client server, forwarding an order confirmation document in relation to the settlement verified product to the client server, and outputting a delivery information.

2. The electronic payment system of claim 1, wherein an analyzing robot which is mountable on the electronic payment engine when the electronic payment program is set up, analyzes a form transferred for the settlement from the web site operating server, and transfers fields required to be inputted, such as an amount of money, to the financial company server.

3. The electronic payment system of claim 1, wherein a delivery place information and a code information pre-assigned by the financial company are registered on the electronic payment engine, a tray including a menu for determining the delivery place and performing the settlement is driven by the electronic payment engine, and a client fills in the fields required to be inputted with data, such as the delivery information and the settlement information, among the analyzed fields by means of the tray and transfers the filling to the web site operating server.

4. The electronic payment system of claim 1, wherein a delivery place information and a code information pre-assigned by the financial company are registered on the electronic payment engine, a tray including a menu for determining the delivery place and performing the settlement is driven by the electronic payment engine, and a client transfers the delivery information and settlement information to the web site operating server by means of the tray.

5. The electronic payment system of claim 4, wherein the tray is adapted to fill an information required to be inputted in a form provided by the web site operating server at the point of settlement.

6. The electronic payment system of claim 4, wherein the electronic payment engine stores a data for a predetermined advertisement, and the try is adapted to output the advertisement to the client server for a predetermined period of time after the authentication request.

7. The electronic payment system of claim 1, wherein the electronic payment engine requests the authentication based on an information containing a settled amount of money and a code pre-assigned by the financial company.

8. The electronic payment system of claim 1, wherein the electronic authentication engine creates an authentication information as a pre-authentication information and transfers the authentication information when the client server requests the authentication, produces a definite authentication number when the web site operating server requests a settlement verification, and transfers the definite authentication number to the web site operating server.

9. The electronic payment system of one among claims 1 to 8, wherein the settlement information includes an information changed based on the client account code, or the card number, which is stipulated in the financial company server.

10. An electronic payment method on Internet for the purpose of realizing an electronic commerce between a client server, a web site operating server and a financial company server, which are connected through Internet, the electronic payment method comprising the steps of:
searching, in the client server, products selling in the web site operating server and selecting a settlement by a client, and outputting a settlement screen of a predetermined form for the settlement;
requesting, in the client server, an authentication for a settled amount of money to the financial company server by using a tray driven by an electronic payment engine in which such an information as a consumer personal information, a delivery information, and a settlement code information pre-assigned by a financial company are registered;
transferring, in the financial company server, an authentication information with respect to the authentication request to the client server;
transferring, in the client server, an order information to the web site operating server by means of the tray with the authentication information as a settlement information;
requesting, in the web site operating server, a settlement verification based on the authentication information transferred from the client server to the financial company server;
transferring, in the financial company server, an information, which has been settlement-verified after being inquired about, upon receiving the settlement request; and
forwarding, in the web site operating server, an order confirmation document and a delivery information to the client server and the delivery company server after receiving the settlement verified information.

11. The method of claim 10, wherein before the authentication requesting step, an settlement screen analyzing step is performed in a manner that a form analyzing robot is mounted on the electronic payment engine to analyze a form of a settlement screen output from the web site operating server.
